(19) United States
(12) Patent Application Publication
(10) Pub. No.: US 2026/0288560 A1
(43) Pub. Date: Sep. 24, 2026

(54) REAL-TIME ANOMALY DETECTION

(71) Applicant: Confluent, Inc., Mountain View, CA (US)

(72) Inventors: Siddharth Bedekar, Redmond, WA (US); Mingge Deng, Kirkland, WA (US); Yash Anand, Redmond, WA (US); Christopher Avery Meyers, Kirkland, WA (US)

(21) Appl. No.: 19/212,320

(22) Filed: May 19, 2025

Related U.S. Application Data
(60) Provisional application No. 63/774,057, filed on Mar. 18, 2025.

(51) Int. Cl. G06F 11/07; G06Q 10/04

(52) U.S. Cl. CPC G06F 11/0772; G06F 11/0727; G06Q 10/04

(57) ABSTRACT

In real-time streaming environments, continuous forecasting allows businesses to anticipate changes, optimize operations, and detect deviations as data flows in. Anomaly detection identifies unexpected deviations, helping improve data quality, detect operational issues instantly, and enable faster decision-making. Instead of waiting for batch processing, real-time anomaly detection continuously monitors data as it arrives, detecting outliers the moment they occur. Using a forecasting model, a prediction interval is determined for each element of received data. If the received data falls outside of the prediction interval, an alert may be generated. The real-time anomaly detection can be accessed via a Structured Query Language (SQL) interface. Thus, real-time anomaly detection can be integrated into a database that receives the data stream.

### PRIORITY CLAIM

This application claims the benefit of priority of U.S. Provisional Patent Application Ser. No. 63/774,057, filed on Mar. 18, 2025, which is hereby incorporated by reference in its entirety.

### TECHNICAL FIELD

The subject matter disclosed herein generally relates to real-time anomaly detection. Specifically, the present disclosure addresses systems and methods for detecting anomalies in data in real-time within a data distribution service.

### BACKGROUND

Time series forecasting and anomaly detection are used in various domains including finance, manufacturing, and telecommunications. Traditional statistical methods for time series analysis have relied on decomposing time series data into trend, seasonal, and irregular components. Autoregressive Integrated Moving Average (ARIMA) models have emerged as a powerful approach. ARIMA models combine autoregressive (AR) components, which capture the relationship between an observation and a specified number of lagged observations, with moving average (MA) components, which model the relationship between an observation and residual errors from a moving average model applied to lagged observations.

Other techniques used for forecasting include exponential smoothing, moving averages, and linear regression. For anomaly detection, traditional approaches include statistical control charts, such as Shewhart charts and CUSUM (cumulative sum) methods, which relied on predefined thresholds and distributional assumptions.

### BRIEF DESCRIPTION OF THE DRAWINGS

Some embodiments are illustrated by way of example and not limitation in the figures of the accompanying drawings.

FIG. 1 is a diagram illustrating relationships among a broker provider, cloud service providers, realms, and networks, according to some example embodiments.

FIG. 2 is a diagram illustrating relationships among a network, container environments, physical clusters, and logical clusters, according to some example embodiments.

FIG. 3 is a diagram of a database schema suitable for use in real-time anomaly detection, according to some example embodiments.

FIG. 4 is a diagram of a user interface suitable for showing results of real-time anomaly detection, according to some example embodiments.

FIG. 5 is a diagram of a user interface suitable for showing results of real-time anomaly detection, according to some example embodiments.

FIG. 6 is a flowchart illustrating operations of a method for real-time anomaly detection, according to some example embodiments.

FIG. 7 is a diagram of an architecture for a data processing framework, according to some example embodiments.

FIG. 8 is a block diagram illustrating components of a machine, according to some example embodiments, able to read instructions from a machine-storage medium and perform any one or more of the methodologies discussed herein.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The cloud comprises a network of servers that are accessible over the Internet and the software and databases that run on those servers. When a resource is being deployed to the cloud, there are many possible locations for the deployment. For example, an application is executed by processors and memory in a physical cluster. The physical cluster may handle many tasks, which may be divided into logical clusters. The physical cluster is one of several physical clusters that are managed by a management system such as Kubernetes™, Nomad™, or Elastic Container Service™ (ECS). The management system executes within a network, such as a US network, a European network, or an Asian network of a cloud provider, such as Amazon Web Services™ (AWS), Microsoft Azure™, or Google Cloud Platform™. A customer of the cloud provider may use multiple accounts, referred to as realms, each of which may access one or more networks of the cloud provider.

As used herein, the generic term for a realm, network, management system, physical cluster, logical cluster, or application is “asset.” Data may be generated or collected at one asset and distributed to one or more other assets.

Forecasting helps predict future values in time-series data by analyzing historical trends. In real-time streaming environments, continuous forecasting allows businesses to anticipate changes, optimize operations, and detect deviations as data flows in.

Anomaly detection identifies unexpected deviations, helping improve data quality, detect operational issues instantly, and enable faster decision-making. Instead of waiting for batch processing, as discussed herein, real-time anomaly detection (also referred to as “continuous anomaly detection”) continuously monitors data as it arrives, detecting outliers the moment they occur.

Using ARIMA or another forecasting model, a prediction interval is determined for each element of received data. If the received data falls outside of the prediction interval, an alert may be generated. In some example embodiments, the prediction interval is the range of plus or minus three standard deviations (3σ) from the predicted mean.

The real-time anomaly detection can be accessed via a Structured Query Language (SQL) interface. A first query may be used to generate real-time forecasts for a data stream. A second query may be used to detect substantial differences between actual data in the data stream and the forecasts. Thus, real-time anomaly detection can be integrated into a database that receives the data stream.

In some example embodiments, the real-time anomaly detection is implemented as a Flink SQL function within a cloud environment. Apache Flink is a distributed processing engine for stateful computations over unbounded and bounded data streams. The implementation as a Flink SQL function allows users to leverage the streaming capabilities of Flink while using familiar SQL syntax.

The Flink SQL implementation provides several advantages over traditional batch processing approaches. First, it allows for true real-time processing of data as it arrives, rather than processing data in batches at fixed intervals. Second, Flink's stateful processing capabilities enable the system to maintain the state of the forecasting model across multiple data points without requiring external storage. Third, Flink's event time processing ensures that data is processed in the correct order regardless of when it arrives, allowing for proper time series analysis.

In some example embodiments, the real-time streaming environment includes a Kafka message queue system. Apache Kafka is a distributed streaming platform designed for building real-time data pipelines and streaming applications. Kafka serves as the primary data source, with data producers pushing data into Kafka topics. Consumers subscribe to topics to read the data. For example, online services may generate metrics data and continuously push this data into Kafka as a message queue or streaming data source.

The Flink SQL engine reads data from Kafka topics in a streaming fashion, processing each message as it arrives. This one-by-one streaming approach enables true real-time processing, as opposed to micro-batch processing that introduces small delays. The integration with Kafka leverages Kafka's durability and scalability features, ensuring that no data is lost even if the processing system temporarily fails.

In some example embodiments, the real-time anomaly detection system serves as a component in a larger event-driven AI system. When an anomaly is detected, it can trigger a series of automated actions or workflows. For example, when an anomaly is detected, the system can trigger an AI agent to analyze logs or other contextual data related to the anomaly, collect relevant diagnostic information from the affected systems, generate alerts through integration with notification systems such as PagerDuty™ or Slack™, initiate automated remediation actions, or any suitable combination thereof.

This event-driven approach allows organizations to respond to anomalies more quickly and with less manual intervention. For example, if the system detects an anomaly in CPU utilization, it can automatically trigger log collection and analysis, potentially identifying the root cause before a human operator needs to intervene.

In some example embodiments, the integration points are implemented using standard messaging protocols, allowing the anomaly detection system to work with existing tools and systems. Configuration options allow users to define which actions should be triggered for different types of anomalies and under what conditions.

The system may operate within a Flink compute pool architecture, which provides the computational resources needed for real-time processing. A Flink compute pool consists of physical compute resources that may be further divided into logical compute pools. Physical compute pools represent the actual hardware resources allocated to Flink processing, including CPU, memory, and network resources. These physical resources may be provisioned in a cloud environment or on-premises infrastructure.

Logical compute pools are virtual divisions of the physical resources, allowing multiple applications or processing tasks to share the same physical infrastructure while maintaining isolation. Each logical compute pool may be assigned specific resource limits and quality of service parameters. The forecasting and anomaly detection functions execute within these compute pools, with the ability to scale horizontally as data volume increases. The system automatically manages the distribution of processing tasks across the available resources, ensuring efficient utilization and fault tolerance. In some example embodiments, the system includes automatic scaling capabilities that adjust the size of the compute pool based on the current processing load, ensuring that sufficient resources are available during peak periods while minimizing costs during periods of lower activity.

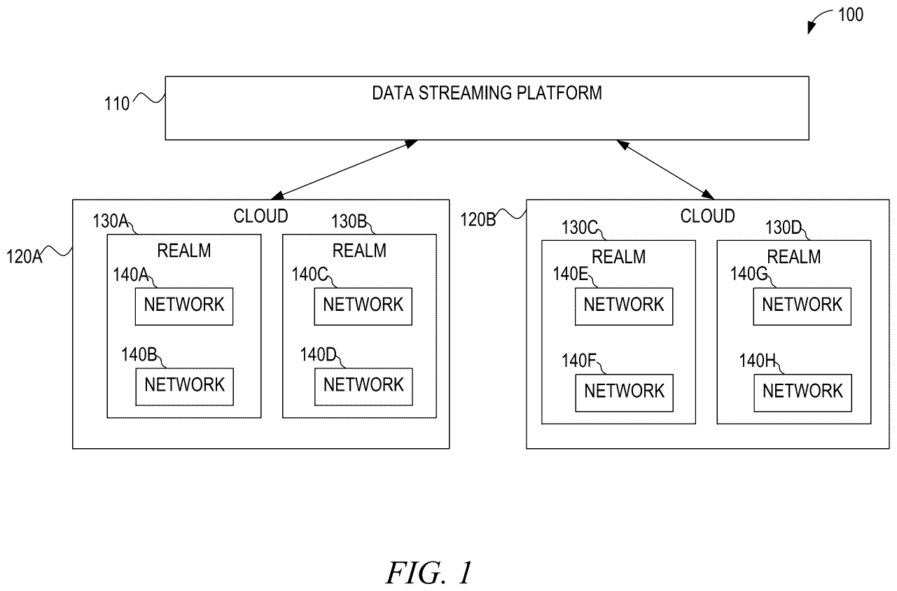

FIG. 1 is a diagram 100 illustrating relationships among a data streaming platform 110; cloud service providers 120A and 120B; realms 130A, 130B, 130C, and 130D; and networks 140A, 140B, 140C, 140D, 140E, 140F, 140G, and 140H, according to some example embodiments. The various elements of FIG. 1 may be referenced by number alone. For example, “a cloud service provider 120” may be used to refer generically to either of the cloud service providers 120A-120B and “the cloud service providers 120” may be used to refer to the cloud service providers 120A-120B collectively. Similarly, “a realm 130” may be used to refer generically to any of the realms 130A-130D and “the realms 130” may be used to refer to the realms 130A-130D collectively. Likewise, “a network 140” may be used to refer generically to any of the networks 140A-140H and “the networks 140” may be used to refer to the networks 140A-140H collectively.

The data streaming platform 110 provides services using applications running on hardware computing resources of one or more cloud service providers 120. To access the cloud service providers 120, the data streaming platform 110 may use multiple accounts, each account having different access credentials (e.g., username and password). The realms 130 represent these separate methods of accessing the cloud service providers 120.

The cloud service provider 120 may provide access to multiple networks 140, such as a US network, a European network, and an Asian network. In addition to, or instead of, being divided by geography, networks may be divided by functionality. For example, the network 140A may provide access to artificial intelligence (AI) tools and the network 140B may not. After connecting to a cloud service provider 120 with an account, thus defining a realm 130, applications are deployed to hardware computing resources of a particular network 140.

Data generated in an asset may be available only in that asset. For example, data generated in a realm may be inaccessible to other realms. Alternatively, data generated in an asset may be accessed when needed by other assets, incurring a high latency as various networks are traversed, communications are encrypted and decrypted, users are authenticated, and the like. To allow cross-asset data access without incurring high latency, a data distribution service may be used.

Whether data is generated in an asset or another asset, the data may be received or accessed as a data stream. As described herein, a forecast may be generated for each subsequent value in the data stream. When a data value is received that is substantially different (e.g., outside of a 90% or 99% probability range) from the forecast, an alert may be generated to report the anomalous value.

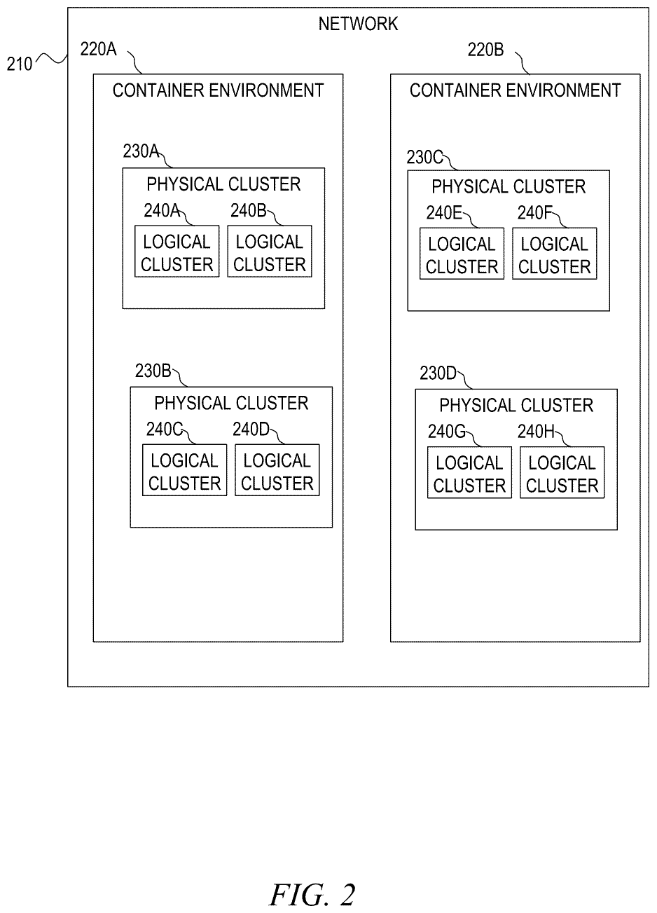

FIG. 2 is a diagram illustrating relationships among a network 210; container environments 220A and 220B; physical clusters 230A, 230B, 230C, and 230D; and logical clusters 240A, 240B, 240C, 240D, 240E, 240F, 240G, and 240H, according to some example embodiments. The various elements of FIG. 2 may be referenced by number alone. For example, “a logical cluster 240” may be used to refer generically to any of the logical clusters 240A-240H and “the logical clusters 240” may be used to refer to the logical clusters 240A-240H collectively.

The network 210 may include multiple container environments 220. For example, the container environments 220A may be separate Kubernetes clusters. The container environments 220 may each make use of multiple physical clusters 230. A physical cluster 230 comprises the actual physical computing hardware on which the application will run. The resources of a physical cluster 230 may be divided into multiple logical clusters 240. Thus, even though two containerized applications of the container environment 220A may execute on the same physical cluster 230A, they may execute in different logical clusters 240A, 240B.

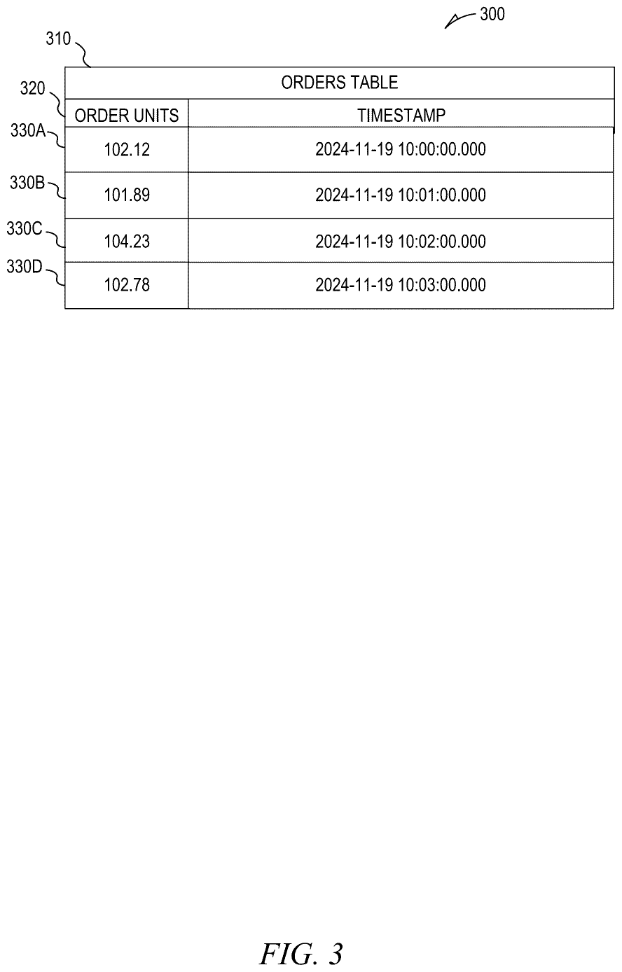

FIG. 3 is a diagram of a database schema 300 suitable for use in real-time anomaly detection, according to some example embodiments. The database schema 300 includes an orders table 310.

The orders table 310 includes rows 330A, 330B, 330C, and 330D of a format 320. By way of example, four rows 330A-330D are shown, but the orders table 310 may include any number of rows, such as one row for each data element in a data stream. Thus, in a system that generates one data element per minute for a period of days, weeks, or months, the orders table may include tens of thousands or millions of rows, an amount of data far beyond the ability of a human mind to process.

As indicated by the format 320, each of the rows 330A-330D includes a number of order units and a timestamp. Thus, the rows 330A-330D show the number of order units for the first four minutes of 10 AM on Nov. 19, 2024. The sequence of values for the number of order units may be used to generate a forecast for a next time period (e.g., the next minute). In response to a determination that a next received value is substantially different from the generated forecast, an alert may be generated to report the anomaly.

In various example embodiments, additional tables may be used or additional fields may be added to the orders table 310. For example, an identifier column may be used to store additional data streams in a single table. Alternatively, additional tables may be used to store additional data streams.

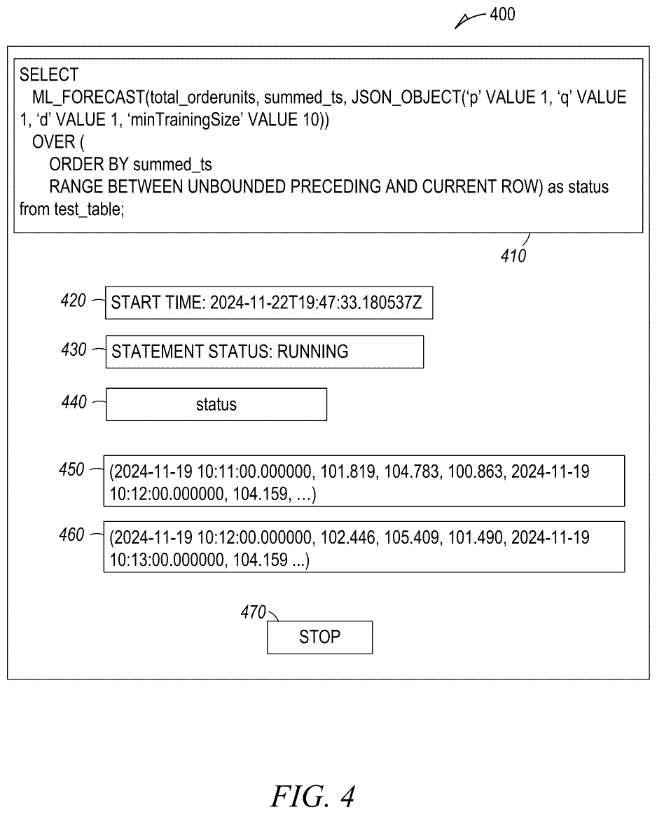

FIG. 4 is a diagram of a user interface 400 suitable for showing results of real-time anomaly detection, according to some example embodiments. The user interface 400 includes a query 410; display fields 420, 430, 440, 450, and 460; and a button 470. The user interface 400 may be generated by a server of one of the physical clusters 230A-230D of FIG. 2, under the control of the data streaming platform 110 of FIG. 1. The user interface 400 may be presented on a display device of a computer connected to the server via a network (e.g., the Internet).

The query 410 may be typed in by a user or selected from a list of predefined queries. In the example of FIG. 4, the query 410 includes parameters for an ML_FORECAST function that uses a machine-learning model to generate a forecast. The “from test_table” portion of the query indicates that the table being used for forecasting is test_table. The “as status” portion of the query indicates that the forecast result will be labeled “status.”

The ML_FORECAST function call takes three parameters. The first parameter identifies the column in which the data value being forecast is held. In this example, “total_orderunits.” The second parameter identifies the column in which the timestamp for the data is held (e.g., “summed_ts”). The third parameter is a JSON object that includes multiple components.

The “p” component defines the order of the AutoRegressive term in ARIMA. The order of the AutoRegressive term is the number of lagged values used in the model and represents how many past values directly influence the current prediction.

The “q” component defines the order of the Moving Average term in ARIMA. The order of the Moving Average term is the number of lagged error terms used in the model and represents how many past prediction errors influence the current prediction.

The “d” component defines the order of differencing in ARIMA. The order of differencing is the number of times the data is differenced to achieve stationarity. For example, zero means no differencing, one means first difference, and so on.

The “minTrainingSize” component defines the minimum number of data points required for training. When fewer data points than this are available, the model will not train.

In various example embodiments, more or fewer components are used. Some or all components may be optional, such that “null” is a valid value and the ML_FORECAST model determines a suitable value to use (e.g., by using a grid search to find a combination based on root-mean-squared error [RMSE]). Some additional components are described below.

An “m” component defines a seasonal period length. An “enableStl” component is a Boolean flag to enable or disable STL (Seasonal and Trend decomposition using Loess). A “maxTrainingSize” component defines a maximum number of historical data points used for training, limiting the training window to recent data. A “horizon” component defines a number of future time periods to forecast. An “updateInterval” component defines a frequency of retraining of the model.

The “OVER (ORDER BY summed_ts RANGE BETWEEN UNBOUNDED PRECEDING AND CURRENT ROW)” portion indicates that all previous rows should be used by the model to generate the forecast, ordered by the timestamp of each data element.

The display fields 420-460 show the results of the query 410. Specifically, the field 420 shows the start time of the current forecast run; the field 430 shows whether the query is currently running; the field 440 shows the name of the forecast variable being displayed; and the fields 450 and 460 show generated forecasts. As the forecast runs, additional forecast fields are displayed.

Each of the fields 450-460 shows data used to generate a forecast and a generated forecast. The generated forecast includes a forecast value and, optionally, a timestamp for the forecast.

The button 470 is operable by the user to cause the forecast query to be stopped. Once stopped, the user may modify the query and resume forecasting.

An anomaly detection command (e.g., ML_ANOMALY_DETECTION) may be run, using the parameters described above for the ML_FORECAST command. In addition to generating a forecast for each value, the anomaly detection command causes the server to compare each received value to the forecast for the value to determine if the received value is anomalous.

The ML_FORECAST and ML_ANOMALY_DETECTION functions are, in some example embodiments, implemented as User-Defined Functions (UDFs) within an Flink SQL environment. These functions can be called directly from SQL queries, allowing users to integrate forecasting and anomaly detection into their existing data processing pipelines without requiring separate systems or complex integration code.

Below is an example of using a tumble window to handle a data stream with multiple values for the same timestamp or non-uniform timestamp intervals between values.

```
CREATE TABLE orderunits_result_anomaly DISTRIBUTED INTO 1
BUCKETS AS WITH windowed_avg AS (
  SELECT
    window_start,
    window_end,
    window_time,
    AVG(total_orderunits) AS avg_total_orderunits
  FROM TABLE(
    TUMBLE(TABLE orders, DESCRIPTOR(summed_ts), INTERVAL
’1’ MINUTE)
  )
  GROUP BY window_start, window_end, window_time
)
SELECT
  window_start,
  avg_total_orderunits,
  ML_ANOMALY_DETECTION(avg_total_orderunits,
window_time, JSON_OBJECT(’enableStl’ VALUE false))
    OVER (
      ORDER BY window_time
      RANGE BETWEEN UNBOUNDED PRECEDING AND
      CURRENT ROW
    ) AS anomaly
FROM windowed_avg;
```

Time series data often arrives at irregular intervals or with multiple data points for the same timestamp. To handle this, the system may implement windowing functionality that aggregates data points within specified time intervals before applying forecasting and anomaly detection algorithms. Windowing may be particularly helpful when processing log data or metrics from multiple sources. For example, when monitoring CPU utilization across multiple servers, each server may report its utilization at slightly different times. By using a tumble window, as shown in the example query above, the system can aggregate all measurements within a one-minute window, computing an average or other aggregate function before applying the forecasting model.

The system may support various types of windows such as tumble windows, sliding windows, and session windows. Tumble windows are fixed-size, non-overlapping windows that divide the timeline into segments of equal duration. Sliding windows are windows of fixed size that slide by a specified interval, potentially overlapping with previous windows. Session windows are windows that group data based on activity sessions, with a timeout parameter defining when a session ends due to inactivity. Window aggregation can be configured through the SQL query, allowing users to specify the window type, size, and aggregation function (e.g., AVG, SUM, MAX) appropriate for their use case.

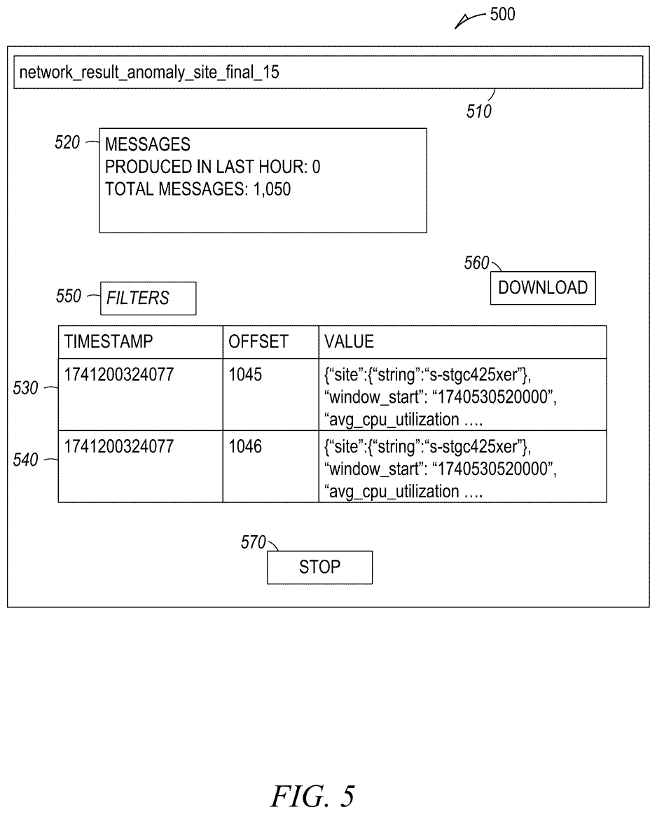

FIG. 5 is a diagram of a user interface 500 suitable for showing results of real-time anomaly detection, according to some example embodiments. The user interface 500 shows display fields 510, 520, 530, and 540 and buttons 550, 560, and 570.

The field 510 indicates the anomaly variable being displayed. The field 520 shows that no messages have been produced in the last hour, but 1,050 messages have been produced so far. The fields 530 and 540 contain data for detected anomalies, including a timestamp, an offset into a series of predictions, and a value that indicates a source of the anomaly, a timestamp of the anomaly, a predicted data value for the timestamp, an anomalous data value at the timestamp, or any suitable combination thereof.

The button 550 is operable to select filters (e.g., source or date filters) to select which anomalies to display. The button 560 is operable to download (e.g., in a comma-separated value [CSV] file) data for the detected anomalies. The button 570 is operable to stop the anomaly detection or reporting.

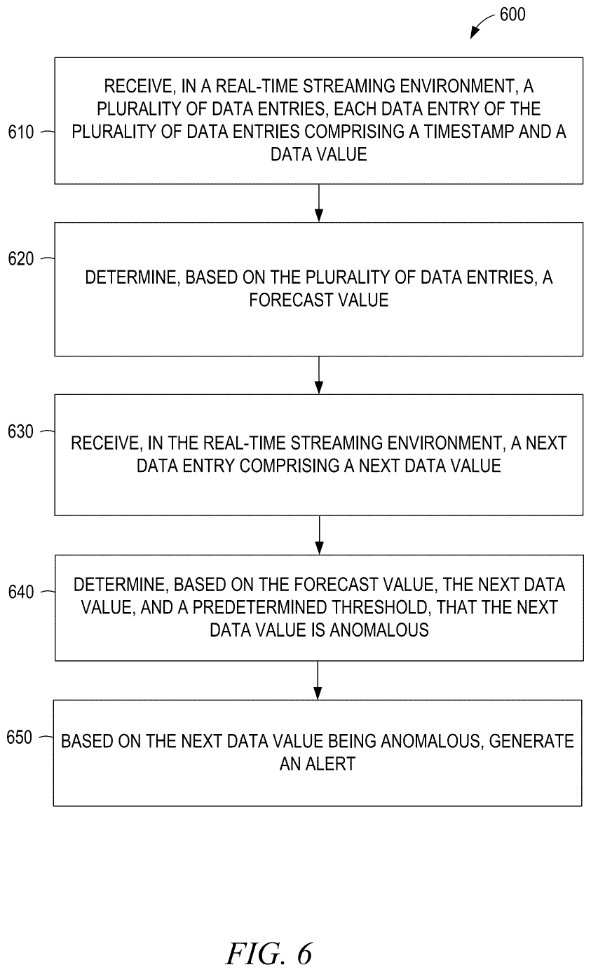

FIG. 6 is a flowchart illustrating operations of a method 600 for real-time anomaly detection, according to some example embodiments. The method 600 includes operations 610, 620, 630, 640, and 650. By way of example and not limitation, the method 600 is described as being performed by one or more physical servers of a physical cluster 230 of FIG. 2.

In operation 610, the server receives, in a real-time streaming environment, a plurality of data entries, each data entry of the plurality of data entries comprising a timestamp and a data value. The timestamp indicates a date and time for which the data value applies. In some example embodiments, the data entries are received individually, as they are generated. Thus, operation 610 occurs over a period of time that is proportional to the number of data entries accessed. In other example embodiments, the data entries are received from a database of past log entries.

The server determines, in operation 620, based on the plurality of data entries, a forecast value. For example, ARIMA may be used to generate a forecast comprising a forecast value and a forecast timestamp.

Operations 610 and 620 may be performed in response to receiving a command to generate forecasts for data values. For example, the query 410 of FIG. 4 may be input or selected by a user to trigger the performance of the method 600. The received command identifies a count of the plurality of data entries to use to generate the forecast value, a number of lagged error terms to use, a number of times data is differenced to achieve stationarity, a seasonal period length, a minimum training size, a maximum training size, a horizon, an update interval, or any suitable combination thereof.

In operation 630, the server receives, in the real-time streaming environment, a next data entry comprising a next data value. This data entry is received from a data stream rather than storage, and is thus a current data entry when it is received.

The server determines, based on the forecast value, the next data value, and a predetermined threshold, that the next data value is anomalous (operation 640). For example, using ARIMA, a prediction interval provides a range within which future values are likely to fall, with an upper and lower bound. For example, a 99% prediction interval means that the true value is expected to fall within the range 99% of the time. Adjusting this interval allows for more or less certainty in forecasts. For anomaly detection, a 3-sigma rule may be applied, assuming data follows a normal distribution.

In a normal distribution, 68% of data falls within one standard deviation (σ) from the mean; 95% of data falls within two standard deviations (2σ) from the mean; and 99.7% of data falls within three standard deviations (3σ) from the mean. Using the 3-sigma rule, any data point that falls outside the 3-sigma range from the corresponding forecast value is an anomalous value and is flagged as an anomaly. Thus, in some example embodiments, the determining that the next data value is anomalous includes determining that a number of standard deviations (e.g., three standard deviations) between the next data value and the forecast value exceeds the predetermined threshold.

Operations 610-630 may be performed repeatedly, generating a new forecast value for each successive next value. Only when a data value is found to be anomalous are operations 640 and 650 performed.

In operation 650, based on the next data value being anomalous, the server generates an alert. For example, a web page may be updated to include information about the forecast, the timestamp, the anomalous value, or any suitable combination thereof. Alternatively, an administrator may be contacted by text message or email. As another option, the generating of the alert may include modifying the next data entry to include an indication that the next data entry is anomalous. For example, the next data entry may be a JSON object that, when received in operation 630, comprises a timestamp element and a value element. After operation 650, the JSON object may be modified to include an “anomalous” element with a value of TRUE, 1, or another value that indicates that the data entry was determined to be anomalous.

In some example embodiments, the system includes visualization methods to help users interpret forecasting and anomaly detection results. For example, the historical data may be shown as a solid line, forecasted values as a dashed line, and anomalies as highlighted points. Confidence intervals for the forecast may be displayed as a shaded area around the forecast line, providing users with a visual indication of the forecast's uncertainty. The visualization system may update in real-time as new data arrives and new forecasts are generated. Users can interact with the visualization to zoom in on specific time periods, hover over data points to see detailed information, or click on anomalies to see additional context about why the point was flagged as anomalous. In some example embodiments, the visualization system includes customizable dashboards where users can arrange multiple visualizations to monitor different aspects of their data simultaneously.

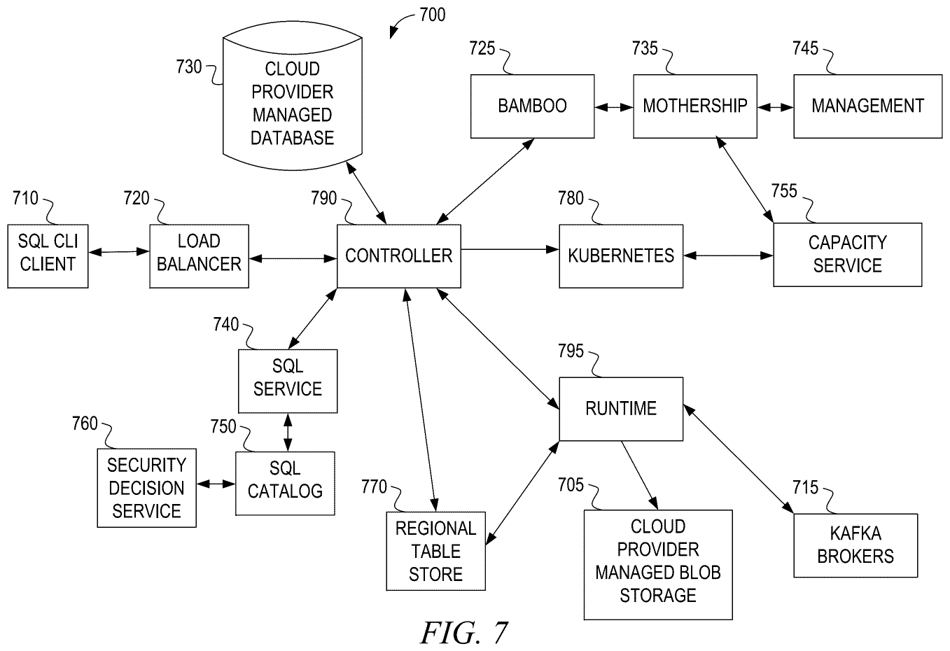

FIG. 7 is a diagram of an architecture 700 for a data processing framework, according to some example embodiments. The architecture 700 includes a cloud provider-managed binary large object (blob) storage 705, a SQL command-line interface (CLI) client 710, Kafka™ brokers 715, a load balancer 720, a synchronizer 725, a cloud provider-managed database 730, a mothership 735, a SQL service 740, a management component 745, a SQL catalog 750, a capacity service 755, a security decision service 760, a regional table store 770, a Kubernetes™ cluster 780, a controller 790, and a runtime 795.

The synchronizer 725 is a synchronization mechanism between a control plane and a data plane. The synchronizer 725, the cloud provider-managed database 730, the mothership 735, the management component 745, the capacity service 755, and the controller 790 are located in the control plane. The Kubernetes™ cluster 780, the SQL service 740, the SQL catalog 750, the security decision service 760, the runtime 795, the regional table store 770, the cloud provider-managed blob storage 705, and the Kafka™ brokers 715 are located in the data plane.

In the architecture 700, the cloud provider-managed database 730, the synchronizer 725, the mothership 735, the management component 745, and the capacity service 755 provide global control. The controller 790 and other components of the control plane are instantiated once for each cell. In some example embodiments, a cell corresponds to a region of a cloud provider. Typically, there is a one-to-one correspondence between topics handled by the Kafka™ brokers 715 and tables in the regional table store 770.

The load balancer 720 receives a query from the SQL CLI client 710 and submits a job to the controller 790. In this example, the client is a CLI client, but a graphical user interface (GUI) client may also be used. The controller 790 will interact with the other components of the architecture 700 to generate results for the query. The results are provided from the controller 790 back to the load balancer 720 and, from there, to the SQL CLI client 710.

The controller 790 persists the query and related data in the cloud provider-managed database 730. In various example embodiments, one or more of the following is persisted: SQL of the query, a user that submitted the query, and an organization that the user belongs to. The controller 790 also sends synchronization metadata to the synchronizer 725. The synchronizer 725 communicates with the mothership 735 to coordinate with the management component 745.

The management component 745 provisions and manages compute pools and clusters that handle queries. For example, the management component 745 may control rollouts and code changes to the Kubernetes™ clusters 780.

The capacity service 755 sends synchronization secrets to the Kubernetes™ cluster 780 that will handle the query, authorizing access to the data. The controller 790 confirms the access authorization with the Kubernetes™ cluster 780 and manages the runtime 795 to generate results for the request. The runtime 795 is unique to each isolation group and helps ensure data security. For example, each organization that makes use of the architecture 700 may use a corresponding unique runtime 795.

The runtime 795 communicates with the Kafka™ brokers 715 to gather data that is responsive to the query. The gathered data is stored in the regional table store 770. The runtime 795 may also store states, such as checkpoints and save points, to the cloud provider-managed blob storage 705. The stored state data may be used for error correction and recovery.

The controller 790 provides the query to the SQL service 740, which compiles a query plan. The SQL service 740 may access the SQL catalog 750 to determine what functions are available. The SQL service 740 or the SQL catalog 750 may access the security decision service 760 to determine if the user is permitted to access the data or functions that are responsive to the query.

If the query is rejected by the security decision service 760, the controller 790 provides a message informing the user that the query cannot be processed. Otherwise, using the query plan, the controller 790 accesses the regional table store 770 to generate results that are passed to the SQL CLI client 710 via the load balancer 720.

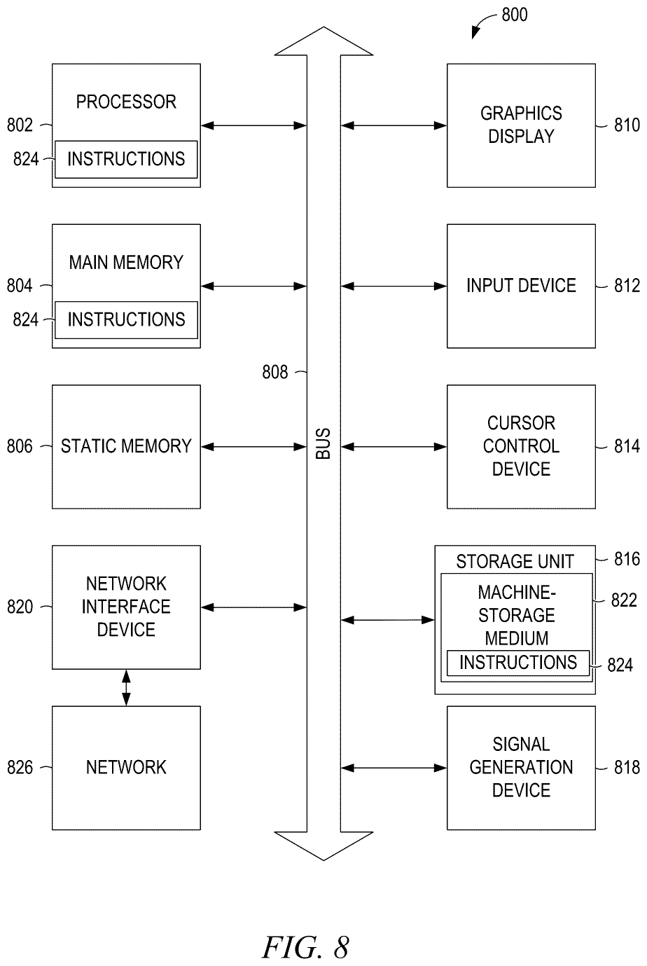

FIG. 8 illustrates components of a machine 800, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 8 shows a diagrammatic representation of the machine 800 in the example form of a computer device (e.g., a computer) and within which instructions 824 (e.g., software, a program, an application, an applet, an app, or other executable code) for causing the machine 800 to perform any one or more of the methodologies discussed herein may be executed, in whole or in part.

For example, the instructions 824 may cause the machine 800 to execute the method 600 of FIG. 6. In one embodiment, the instructions 824 can transform the general, non-programmed machine 800 into a particular machine (e.g., specially configured machine) programmed to carry out the described and illustrated functions in the manner described.

In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824 (sequentially or otherwise) that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The processor 802 may contain microcircuits that are configurable, temporarily or permanently, by some or all of the instructions 824 such that the processor 802 is configurable to perform any one or more of the methodologies described herein, in whole or in part. For example, a set of one or more microcircuits of the processor 802 may be configurable to execute one or more modules (e.g., software modules) described herein.

The machine 800 may further include a graphics display 810 (e.g., a plasma display panel (PDP), a light emitting diode (LED) display, a liquid crystal display (LCD), a projector, or a cathode ray tube (CRT), or any other display capable of displaying graphics or video). The machine 800 may also include an input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a sound card, an amplifier, a speaker, a headphone jack, or any suitable combination thereof), and a network interface device 820.

The storage unit 816 includes a machine-storage medium 822 (e.g., a tangible machine-storage medium) on which is stored the instructions 824 (e.g., software) embodying any one or more of the methodologies or functions described herein. The instructions 824 may also reside, completely or at least partially, within the main memory 804, within the processor 802 (e.g., within the processor's cache memory), or both, before or during execution thereof by the machine 800. Accordingly, the main memory 804 and the processor 802 may be considered as machine-storage media (e.g., tangible and non-transitory machine-storage media). The instructions 824 may be transmitted or received over a communication network 826 via the network interface device 820.

In some example embodiments, the machine 800 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (e.g., 804, 806, and/or memory of the processor(s) 802) and/or storage unit 816 may store one or more sets of instructions 824 and data structures (e.g., software) embodying or utilized by any one or more of the methodologies or functions described herein. These instructions, when executed by processor(s) 802 cause various operations to implement the disclosed embodiments.

As used herein, the terms “machine-storage medium,” “device-storage medium,” “computer-storage medium” (referred to collectively as “machine-storage medium 822”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage medium 822 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The machine-storage medium 822 specifically excludes carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 824 may further be transmitted or received over a communication network 826 using a transmission medium via the network interface device 820 and utilizing any one of a number of well-known transfer protocols (e.g., HTTP). Examples of communication networks 826 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 824 for execution by the machine 800, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface [API]).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

In view of the disclosure above, various examples are set forth below. It should be noted that one or more features of an example, taken in isolation or combination, should be considered within the disclosure of this application.

### EXAMPLES

Example 1 is a system comprising: one or more hardware processors; and one or more memories coupled to the one or more hardware processors, the one or more memories storing instructions that, when executed by the one or more hardware processors, cause the one or more hardware processors to perform operations comprising: receiving, in a real-time streaming environment, a plurality of data entries, each data entry of the plurality of data entries comprising a timestamp and a data value; determining, based on the plurality of data entries, a forecast value; receiving, in the real-time streaming environment, a next data entry comprising a next data value; determining, based on the forecast value, the next data value, and a predetermined threshold, that the next data value is anomalous; and based on the next data value being anomalous, generating an alert.

In Example 2, the subject matter of Example 1, wherein the determining that the next data value is anomalous comprises determining that a number of standard deviations between the next data value and the forecast value exceeds the predetermined threshold.

In Example 3, the subject matter of Example 2, wherein the predetermined threshold is three standard deviations.

In Example 4, the subject matter of Examples 1-3, wherein the operations further comprise: receiving a command to generate the forecast value, the command identifying at least one of a count of the plurality of data entries to use to generate the forecast value, a number of lagged error terms to use, a number of times data is differenced to achieve stationarity, a seasonal period length, a minimum training size, a maximum training size, a horizon, and an update interval.

In Example 5, the subject matter of Examples 1-4, wherein the operations further comprise: receiving a command to generate the forecast value, the command identifying a count of the plurality of data entries to use to generate the forecast value, a number of lagged error terms to use, a number of times data is differenced to achieve stationarity, a seasonal period length, a minimum training size, a maximum training size, a horizon, and an update interval.

In Example 6, the subject matter of Examples 1-5, wherein the generating of the alert comprises updating a web page.

In Example 7, the subject matter of Examples 1-6, wherein the generating of the alert comprises modifying the next data entry to include an indication that the next data entry is anomalous.

Example 8 is a method comprising: receiving, in a real-time streaming environment, a plurality of data entries, each data entry of the plurality of data entries comprising a timestamp and a data value; determining, based on the plurality of data entries, a forecast value; receiving, in the real-time streaming environment, a next data entry comprising a next data value; determining, based on the forecast value, the next data value, and a predetermined threshold, that the next data value is anomalous; and based on the next data value being anomalous, generating an alert.

In Example 9, the subject matter of Example 8, wherein the determining that the next data value is anomalous comprises determining that a number of standard deviations between the next data value and the forecast value exceeds the predetermined threshold.

In Example 10, the subject matter of Example 9, wherein the predetermined threshold is three standard deviations.

In Example 11, the subject matter of Examples 8-10 includes receiving a command to generate the forecast value, the command identifying at least one of a count of the plurality of data entries to use to generate the forecast value, a number of lagged error terms to use, a number of times data is differenced to achieve stationarity, a seasonal period length, a minimum training size, a maximum training size, a horizon, and an update interval.

In Example 12, the subject matter of Examples 8-11 includes receiving a command to generate the forecast value, the command identifying a count of the plurality of data entries to use to generate the forecast value, a number of lagged error terms to use, a number of times data is differenced to achieve stationarity, a seasonal period length, a minimum training size, a maximum training size, a horizon, and an update interval.

In Example 13, the subject matter of Examples 8-12, wherein the generating of the alert comprises updating a web page.

In Example 14, the subject matter of Examples 8-13, wherein the generating of the alert comprises modifying the next data entry to include an indication that the next data entry is anomalous.

Example 15 is one or more machine-storage media comprising instructions that, when executed by one or more hardware processors of a one or more computers, cause the one or more computers to perform operations comprising: receiving, in a real-time streaming environment, a plurality of data entries, each data entry of the plurality of data entries comprising a timestamp and a data value; determining, based on the plurality of data entries, a forecast value; receiving, in the real-time streaming environment, a next data entry comprising a next data value; determining, based on the forecast value, the next data value, and a predetermined threshold, that the next data value is anomalous; and based on the next data value being anomalous, generating an alert.

In Example 16, the subject matter of Example 15, wherein the determining that the next data value is anomalous comprises determining that a number of standard deviations between the next data value and the forecast value exceeds the predetermined threshold.

In Example 17, the subject matter of Example 16, wherein the predetermined threshold is three standard deviations.

In Example 18, the subject matter of Examples 15-17, wherein the operations further comprise: receiving a command to generate the forecast value, the command identifying at least one of a count of the plurality of data entries to use to generate the forecast value, a number of lagged error terms to use, a number of times data is differenced to achieve stationarity, a seasonal period length, a minimum training size, a maximum training size, a horizon, and an update interval.

In Example 19, the subject matter of Examples 15-18, wherein the operations further comprise: receiving a command to generate the forecast value, the command identifying a count of the plurality of data entries to use to generate the forecast value, a number of lagged error terms to use, a number of times data is differenced to achieve stationarity, a seasonal period length, a minimum training size, a maximum training size, a horizon, and an update interval.

In Example 20, the subject matter of Examples 15-19, wherein the generating of the alert comprises updating a web page.

Example 21 is an apparatus comprising means to implement any of Examples 1-20.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system comprising:
one or more hardware processors; and
one or more memories coupled to the one or more hardware processors, the one or more memories storing instructions that, when executed by the one or more hardware processors, cause the one or more hardware processors to perform operations comprising:
receiving, in a real-time streaming environment, a plurality of data entries, each data entry of the plurality of data entries comprising a timestamp and a data value;
determining, based on the plurality of data entries, a forecast value;
receiving, in the real-time streaming environment, a next data entry comprising a next data value;
determining, based on the forecast value, the next data value, and a predetermined threshold, that the next data value is anomalous; and
based on the next data value being anomalous, generating an alert.

2. The system of claim 1, wherein the determining that the next data value is anomalous comprises determining that a number of standard deviations between the next data value and the forecast value exceeds the predetermined threshold.

3. The system of claim 2, wherein the predetermined threshold is three standard deviations.

4. The system of claim 1, wherein the operations further comprise:
receiving a command to generate the forecast value, the command identifying at least one of a count of the plurality of data entries to use to generate the forecast value, a number of lagged error terms to use, a number of times data is differenced to achieve stationarity, a seasonal period length, a minimum training size, a maximum training size, a horizon, and an update interval.

5. The system of claim 1, wherein the operations further comprise:
receiving a command to generate the forecast value, the command identifying a count of the plurality of data entries to use to generate the forecast value, a number of lagged error terms to use, a number of times data is differenced to achieve stationarity, a seasonal period length, a minimum training size, a maximum training size, a horizon, and an update interval.

6. The system of claim 1, wherein the generating of the alert comprises updating a web page.

7. The system of claim 1, wherein the generating of the alert comprises modifying the next data entry to include an indication that the next data entry is anomalous.

8. A method comprising:
receiving, in a real-time streaming environment comprising at least one hardware processor, a plurality of data entries, each data entry of the plurality of data entries comprising a timestamp and a data value;
determining, based on the plurality of data entries, a forecast value;
receiving, in the real-time streaming environment, a next data entry comprising a next data value;
determining, based on the forecast value, the next data value, and a predetermined threshold, that the next data value is anomalous; and
based on the next data value being anomalous, generating an alert.

9. The method of claim 8, wherein the determining that the next data value is anomalous comprises determining that a number of standard deviations between the next data value and the forecast value exceeds the predetermined threshold.

10. The method of claim 9, wherein the predetermined threshold is three standard deviations.

11. The method of claim 8, further comprising:
receiving a command to generate the forecast value, the command identifying at least one of a count of the plurality of data entries to use to generate the forecast value, a number of lagged error terms to use, a number of times data is differenced to achieve stationarity, a seasonal period length, a minimum training size, a maximum training size, a horizon, and an update interval.

12. The method of claim 8, further comprising:
receiving a command to generate the forecast value, the command identifying a count of the plurality of data entries to use to generate the forecast value, a number of lagged error terms to use, a number of times data is differenced to achieve stationarity, a seasonal period length, a minimum training size, a maximum training size, a horizon, and an update interval.

13. The method of claim 8, wherein the generating of the alert comprises updating a web page.

14. The method of claim 8, wherein the generating of the alert comprises modifying the next data entry to include an indication that the next data entry is anomalous.

15. At least one machine-storage medium comprising instructions that, when executed by one or more hardware processors of a one or more computers, cause the one or more computers to perform operations comprising:
receiving, in a real-time streaming environment, a plurality of data entries, each data entry of the plurality of data entries comprising a timestamp and a data value;
determining, based on the plurality of data entries, a forecast value;
receiving, in the real-time streaming environment, a next data entry comprising a next data value;
determining, based on the forecast value, the next data value, and a predetermined threshold, that the next data value is anomalous; and
based on the next data value being anomalous, generating an alert.

16. The at least one machine-storage medium of claim 15, wherein the determining that the next data value is anomalous comprises determining that a number of standard deviations between the next data value and the forecast value exceeds the predetermined threshold.

17. The at least one machine-storage medium of claim 16, wherein the predetermined threshold is three standard deviations.

18. The at least one machine-storage medium of claim 15, wherein the operations further comprise:
receiving a command to generate the forecast value, the command identifying at least one of a count of the plurality of data entries to use to generate the forecast value, a number of lagged error terms to use, a number of times data is differenced to achieve stationarity, a seasonal period length, a minimum training size, a maximum training size, a horizon, and an update interval.

19. The at least one machine-storage medium of claim 15, wherein the operations further comprise:
receiving a command to generate the forecast value, the command identifying a count of the plurality of data entries to use to generate the forecast value, a number of lagged error terms to use, a number of times data is differenced to achieve stationarity, a seasonal period length, a minimum training size, a maximum training size, a horizon, and an update interval.

20. The at least one machine-storage medium of claim 15, wherein the generating of the alert comprises updating a web page.
